(19) United States
(12) Patent Application Publication
(10) Pub. No.: US 2007/0092330 A1
(43) Pub. Date: Apr. 26, 2007

(54) Playstation bracket

(75) Inventors: Brian K. Zeilinger, Janesville, WI (US); Ernesto Huerta, Mukwonago, WI (US)

Correspondence Address: MICHAEL BEST & FRIEDRICH, LLP, 100 E WISCONSIN AVENUE, Suite 3300, MILWAUKEE, WI, 53202, US

(73) Assignee: PlayStar, Inc., Janesville, WI (US)

(21) Appl. No.: 11/247,670

(22) Filed: Oct. 11, 2005

(51) Int. Cl. A47F 5/00; B25G 3/00

(52) U.S. Cl. 403/231; 248/300

(57) ABSTRACT

A bracket configured to connect two frame members. The bracket comprises of a first side and a second side. The first side includes a first alignment member to align a first frame member with respect to the bracket and the second side includes a second alignment member to align a second frame member with respect to the bracket. The bracket is suited for use in assembling children's playstations.

### FIELD OF THE INVENTION

The present invention relates to brackets for interconnecting frame members, and more particularly to brackets for interconnecting frame members of a playstation.

### BACKGROUND OF THE INVENTION

It is common for playstations to be supplied to the user unassembled. The playstation may include hardware, frame members, and brackets requiring assembly. It is known to provide the brackets for interconnecting the frame members, typically wood boards. The brackets often include pre-drilled holes to receive a fastener that secures the bracket to the board. Other frame members are then secured to the bracket for interconnecting frame members.

### SUMMARY

The present invention provides a bracket for interconnecting frame members of a playstation. More specifically, the frame members can be used to form playstation sub-assemblies that support components, such as climbing bars, climbing walls or ladders. Typically, two different brackets are required to assemble the frame members of these sub-assemblies. One bracket is required for the left side of the sub-assembly and another bracket is required for the right side. The brackets are not interchangeable and assembly can be confusing for the user. Furthermore, two different brackets must be manufactured, thus increasing the cost of the playstation. The present invention cures these deficiencies by providing a single bracket that can be used for either the left or right side of playstation sub-assemblies. The bracket includes alignment features on oppositely facing sides of the bracket to assist the user with assembly.

In one embodiment, the invention provides a bracket configured to connect two frame members. The bracket comprises of a first side and a second side. A first alignment member on the first side is configured to align a first frame member with respect to the bracket. A second alignment member on the second side is configured to align a second frame member with respect to the bracket.

In another embodiment the invention provides a playstation comprising a first frame member, a second frame member, and a bracket. The bracket includes a first side and a second side. A first alignment member on the first side is configured to align the first frame member with respect to the bracket. A second alignment member on the second side is configured to align the second frame member with respect to the bracket.

In yet another embodiment the invention provides a playstation comprising four frame members and two substantially identical brackets. The four frame members define a frame sub-assembly. A first alignment member on a first side of a first bracket is configured to align a first frame member with respect to the first bracket. A second alignment member on a second side of the first bracket is configured to align a second frame member with respect to the first bracket. A first alignment member on a first side of a second bracket is configured to align a third frame member with respect to the second bracket. A second alignment member on a second side of the second bracket is configured to align a fourth frame member with respect to the second bracket.

Other aspects of the invention will become apparent by consideration of the detailed description and accompanying drawings.

### BRIEF DESCRIPTION OF THE DRAWINGS

FIG. 1 is a perspective view of a playstation including a bracket embodying the present invention.

FIG. 2 is an enlarged perspective view showing a frame sub-assembly of the playstation of FIG. 1.

FIG. 3 is a perspective view of the bracket embodying the present invention.

FIG. 4 is an end view of a left side of the frame sub-assembly showing the frame members exploded from the bracket.

FIG. 5 is a partially assembled view of the left side showing the frame members aligned with the bracket and the fasteners exploded.

FIG. 6 is an end view of a right side of the frame sub-assembly showing the frame members exploded from the bracket.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

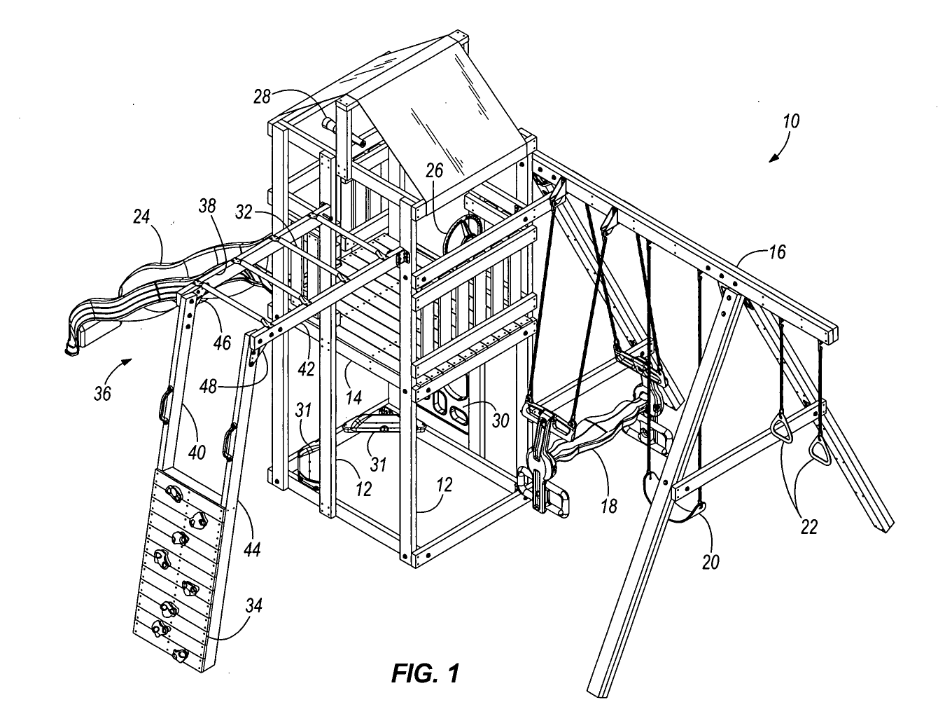

FIG. 1 illustrates a playstation 10 for use by children for recreational play. The playstation 10 includes a plurality of uprights or legs 12 that support an elevated support structure or platform 14 above a lower support surface, such as the ground. A beam 16 can be coupled to one of the legs 12 to support playstation accessories, such as, a two-person swing ride 18, a swing 20, or rings 22. Furthermore, the playstation 10 may include additional accessories, such as a slide 24, a steering wheel 26, a viewing device 28, a vertical climbing wall 30 and a sandbox seat 31.

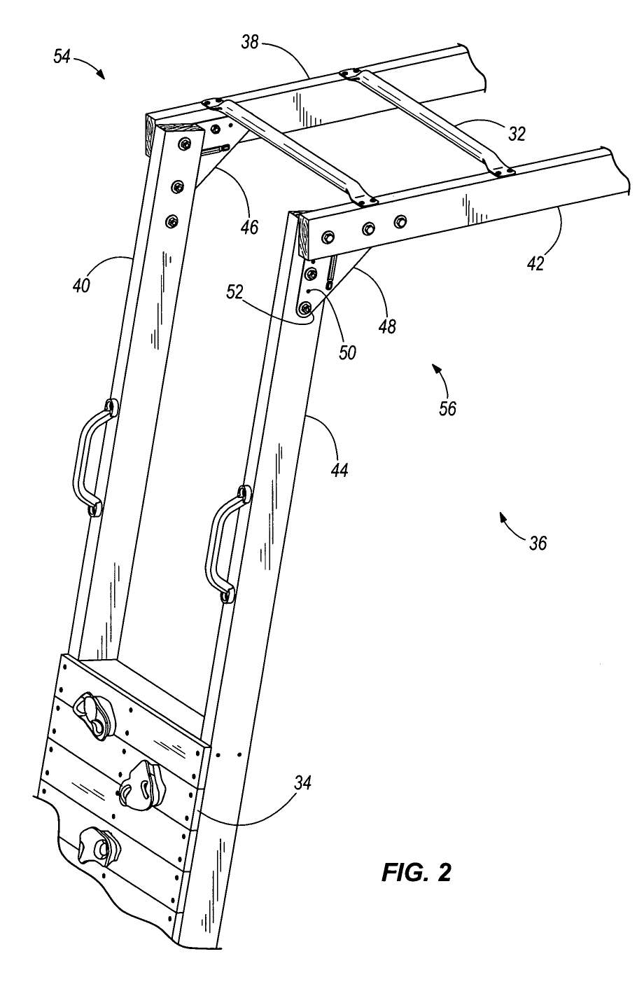

With continued reference to FIG. 1, the playstation 10 may also include components, such as monkey bars 32 and a rock climbing wall 34. These components are typically coupled to a frame sub-assembly 36. FIG. 2 illustrates a portion of the frame sub-assembly 36 which includes the rock climbing wall 34 and the monkey bars 32. Of course other components, such as ladder rungs, rings, and other climbing components could be supported by the frame sub-assembly 36. The frame sub-assembly 36 includes four interconnected frame members 38, 40, 42, 44 that are aligned and interconnected using brackets 46, 48 and fasteners 50, 52. The frame members 38, 40 together define a left side 54 of the frame sub-assembly 36 and frame members 42, 44 together define a right side 56 of the frame sub-assembly 36. The rock climbing wall 34 and the monkey bars 32 extend between the left and right sides 54, 56 of the frame sub-assembly 36. Although the illustrated frame sub-assembly 36 includes four frame members 38, 40, 42, 44 interconnected using two brackets 46, 48, the frame sub-assembly 36 may include any number of frame members and brackets. Furthermore, the illustrated frame members 38, 40, 42, 44 are standard 2 x 4 wood boards, however, any suitable material, such as, steel, aluminum or plastic, in any suitable dimensions, can be used.

As illustrated in FIG. 2, the frame sub-assembly 36 includes two substantially identical brackets 46, 48. The first bracket 46 is configured to connect the frame members 38, 40 to form the left side 54 of the frame sub-assembly 36. The second bracket 48 is configured to connect the frame members 42, 44 to form the right side 56 of the frame sub-assembly 36. The illustrated brackets 46, 48 are configured to connect two frame members, however, it should be understood that the brackets 46, 48 can also connect more than two frame members.

In view of the fact that the brackets 46, 48 are substantially identically, only one bracket, will be described in detail below. It should be understood that the brackets 46, 48 will each include the following described features and are interchangeable.

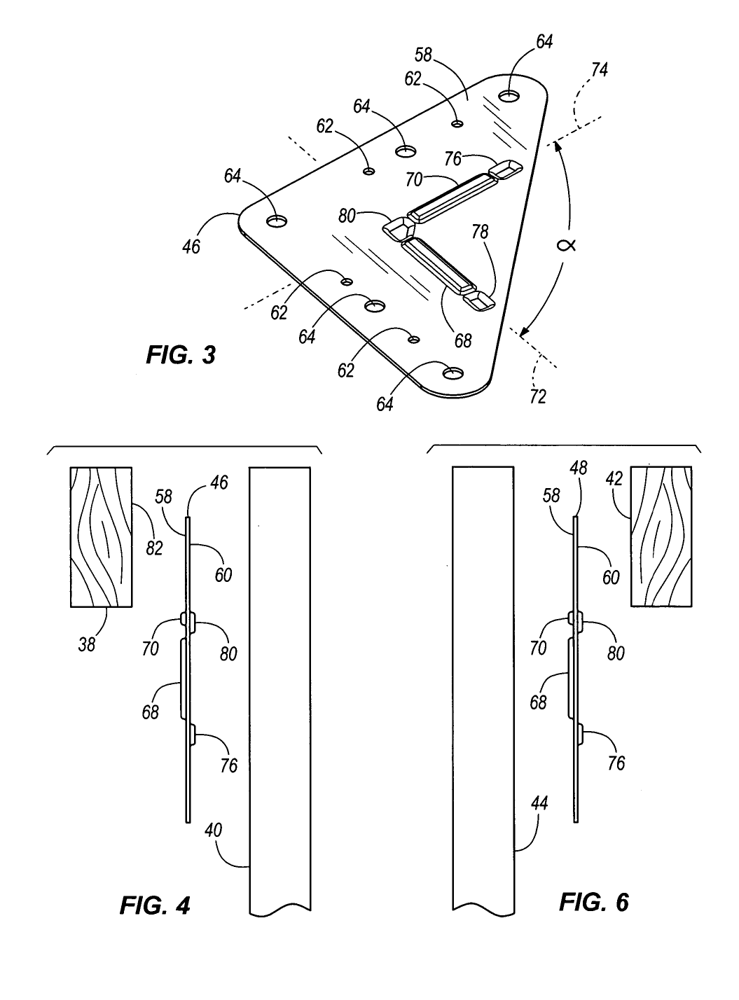

Referring to FIGS. 3 and 4, the bracket 46 is generally planar and triangular in shape and includes oppositely facing sides 58, 60. The bracket 46 also includes two series of circular apertures 62, 64 extending therethrough, the purpose of which will be discussed below. It should be understood that apertures of any shape or size can be used. The bracket 46 is generally thin in cross section and can be formed from any suitable material, such as, steel, aluminum or plastic.

Referring to FIG. 3, the first side 58 of the bracket 46 includes alignment members 68, 70. The first alignment member 68 defines a first axis 72 and the second alignment member 70 defines a second axis 74. The illustrated axes 72, 74 extend through the center of the planar portion of the bracket 46 and intersect to define an alignment angle α therebetween, the purpose of which will be discussed below. The illustrated alignment members 68, 70 are protrusions that extend outwardly from the first side 58 and that are formed by stamping the bracket 46. The alignment members 68, 70 are generally parallel with respective edges of the bracket 46 and are generally elongated when compared to alignment members 76, 78, 80 (discussed below) on the second side 60 of the bracket 46. The illustrated alignment members 68, 70 take one form of protrusion, however, other forms of projections or protrusions are also contemplated. For example, the alignment members 68, 70 could alternatively be formed from punched tabs or flaps extending outwardly from the first side 58, or could be separate members coupled to the first side 58 of the bracket 46. While the illustrated alignment members 68, 70 are illustrated as being protrusions, it should be understood that the alignment members 68, 70 can take other forms such as marked or embossed lines, other markings or apertures. Furthermore, although the first side 58 of the illustrated bracket 46 includes two alignment members 68, 70, any number of alignment members can be used.

Referring to FIGS. 3 and 4, the second side 60 of the bracket 46 includes three alignment members 76, 78, 80. The third alignment member 76 is generally co-axial with the second axis 74 and the fourth alignment member 78 is generally co-axial with the first axis 72 (see FIG. 3). The fifth alignment member 80 includes a portion that is generally co-axial with the first axis 72 and a portion that is generally co-axial with the second axis 74. In other words, the fifth alignment member 80 is positioned at an intersection of the axes 72, 74. The illustrated alignment members 76, 78, 80 of the second side 60 are protrusions that extend outwardly from the second side 60 and that are formed by stamping the bracket 46. Similar to the alignment members 68, 70, the alignment members 76, 78, 80 are generally parallel with respective edges of the bracket 46. The illustrated alignment members 76, 78, 80 take one form of protrusion, however, other forms of projections or protrusions are also contemplated. For example, the alignment members 76, 78, 80 could alternatively be formed from punched tabs or flaps extending outwardly from the second side 60, or could be separate members coupled to the second side 60 of the bracket 46. While the illustrated alignment members 76, 78, 80 are illustrated as being protrusions, it should be understood that the alignment members 76, 78, 80 can take other forms such as marked or embossed lines, other markings or apertures. Furthermore, although the second side 60 of the illustrated bracket 46 includes three alignment members 76, 78, 80, any number of alignment members can be used.

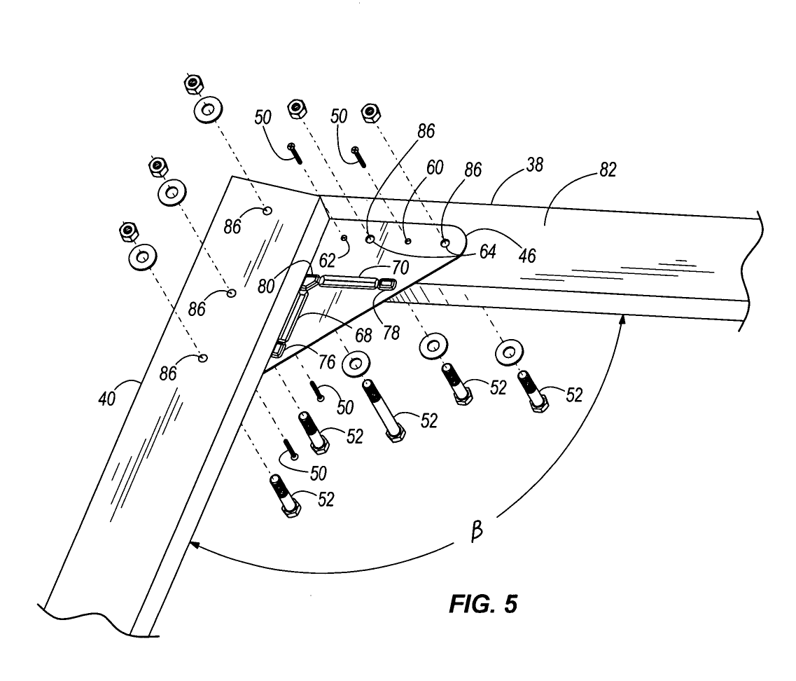

Referring to FIG. 5, the bracket 46 is configured to connect and align the first frame member 38 with the second frame member 40. FIG. 5 illustrates the first bracket 46 configured to connect the first and second frame members 38, 40 to form the left side 54 of the frame sub-assembly 36.

Referring to FIGS. 4 and 5, to connect and align the first frame member 38 to the second frame member 40 the bracket 46 is placed upon a face 82 of the first frame member 38 such that the second alignment member 70 on the first side 58 of the bracket 46 abuts and aligns the edge of the first frame member 38. The bracket 46 is coupled to the first frame member 38 using fasteners 50 positioned through the apertures 62. The fasteners 50 are preferably screws, but may include any suitable fastener, such as nails. A fastener, such as a screw or nail, which can quickly and easily couple the bracket 46 to the frame member 38, is preferred. Next, with the bracket 46 in the desired position, holes 86 can be drilled through the first frame member 38 using the apertures 64 as guides (see FIG. 5). As will be discussed below, after the second frame member 40 is aligned and coupled to the bracket 46, more substantial fasteners, such as bolts 52, can be placed through the holes 86 to couple the bracket 46 to the frame member 38.

Next, the second frame member 40 is placed on the second side 60 of the bracket 46 such that the third and fifth alignment members 76, 80 abut and align an edge of the second frame member 40. The frame members 38, 40 are now aligned at a frame angle β substantially equal to the alignment angle α The bracket 46 is coupled to the second frame member 40 using the fasteners 50 in substantially the same method described above to couple the frame member 38 to the bracket 46. The frame angle β and the alignment angle α are between about 90 degrees and 110 degrees. It should be understood that other angles could be chosen and the alignment members 68, 70, 76, 78 and 80 re-orientated accordingly.

Next, with the bracket 46 in the desired position, holes 86 can be drilled through the second frame member 40 using the apertures 64 and one hole 86 in the first frame member 38 as guides (see FIG. 5). Fasteners 52 can then be placed through the apertures 64 and the holes 86 to couple the bracket 46 to the frame members 38, 40. The fasteners 52 are preferably a bolt and nut combination, but may include any suitable fastener.

The frame members 38, 40 are now coupled and aligned to form the left side 54 of the frame sub-assembly 36. FIG. 2 illustrates that the second bracket 48 can be used to interconnect and align the third and fourth frame members 42, 44 to create the right side 56 of the frame sub-assembly 36. The right side 56 of the frame sub-assembly 36 can be assembled using nearly the same method described above to assemble the first and second frame member 38, 40 to form the left side 54.

Referring to FIG. 6, to form the right side 56 of the frame sub-assembly 36 the third frame member 42 is placed on the second side 60 of the second bracket 48. An edge of the third frame member 42 is then positioned to abut and align with the fourth and fifth alignment members 78, 80. The third frame member 42 is then coupled to the second bracket 48 using the fasteners 50 and the holes 86 are drilled, as described above.

Next, the fourth frame member 44 is positioned against the first side 58 of the second bracket 48 such that an edge of the fourth frame member 44 abuts and aligns with the first alignment member 68. The frame members 42, 44 are now aligned relative to each other at an angle substantially equal to the alignment angle β and the frame angle β of the left side 54 (see FIG. 5). Referring to FIG. 2, the fourth frame member 44 can then be coupled to the bracket 48 using the fasteners 50. After the holes 86 are drilled in the fourth frame member 44, the frame members 42, 44 can be coupled to the bracket 48 using the fasteners 52, as described above for the left side 54.

Next, as seen in FIG. 2, the frame members 42, 44, which are connected and aligned by the second bracket 48 to form the right side 56, can be interconnected to the left side 54. The monkey bars 32 and the rock climbing wall 34 are positioned to extend between and interconnect the left side 54 to the right side 56 to form the frame sub-assembly 36. The frame sub-assembly 36 can then be coupled to the playstation 10. It should be understood that the frame sub-assembly 36 of the playstation 10 is just one application for the brackets 46, 48. The brackets 46, 48 can also be used to align and interconnect other frame members of the playstation 10.

Thus, the invention provides, among other things, a single bracket designed for intuitively aligning and interconnecting both left side and right side frame members that are assembled in mirror relation to one another. The unique configuration and orientation of the alignment members 68, 70, 76, 78, and 80 facilitates assembly for both the left side and the right side of a frame sub-assembly. Various features and advantages of the invention are set forth in the following claims.

What is claimed is:

1. A bracket configured to connect two frame members, the bracket comprising:
a first side;
a second side;
a first alignment member on the first side of the bracket configured to align a first frame member with respect to the bracket; and
a second alignment member on the second side of the bracket configured to align a second frame member with respect to the bracket.

2. The bracket of claim 1, wherein the alignment members are protrusions.

3. The bracket of claim 2, wherein the alignment members are formed by stamping the bracket.

4. The bracket of claim 2, wherein the bracket is substantially planar except for the protrusions.

5. The bracket of claim 1, wherein the first alignment member includes a first portion defining a first axis and a second portion defining a second axis, the two axes defining therebetween an alignment angle, and the second alignment member includes a third portion generally co-axial with the first portion and a fourth portion generally co-axial with the second portion.

6. The bracket of claim 5, wherein the alignment angle is between about 90 degrees and 110 degrees.

7. The bracket of claim 5, wherein the second alignment member further includes a fifth portion positioned generally at a position where the first and second axes intersect.

8. The bracket of claim 1, wherein the first alignment member is generally elongated compared to the second alignment member.

9. The bracket of claim 1, wherein the bracket is generally triangular.

10. The bracket of claim 1, wherein the first and second alignment members are substantially parallel to an edge of the bracket.

11. The bracket of claim 1, wherein the bracket includes a first and a second series of apertures extending therethrough, the first series of apertures configured to receive a first fastener to couple the bracket to a frame member and the second series of apertures configured to receive a second fastener different from the first fastener to couple the bracket to a frame member.

12. A playstation comprising:
a first frame member;
a second frame member; and
a bracket including:
a first side;
a second side;
a first alignment member on the first side of the bracket configured to align the first frame member with respect to the bracket; and
a second alignment member on the second side of the bracket configured to align the second frame member with respect to the bracket.

13. The playstation of claim 12, wherein the alignment members are protrusions.

14. The playstation of claim 13, wherein the alignment members are formed by stamping the bracket.

15. The playstation of claim 13, wherein the bracket is substantially planar except for the protrusions.

16. The bracket of claim 12, wherein the first alignment member includes a first portion defining a first axis and a second portion defining a second axis, the two axes defining therebetween an alignment angle, and the second alignment member includes a third portion generally co-axial with the first portion and a fourth portion generally co-axial with the second portion.

17. The playstation of claim 16, wherein the alignment angle is between about 90 degrees and 110 degrees.

18. The playstation of claim 16, wherein the second alignment member further includes a fifth portion positioned generally at a position where the first and second axes intersect.

19. The playstation of claim 12, wherein the first alignment member is generally elongated compared to the second alignment member.

20. The playstation of claim 12, wherein the bracket is generally triangular.

21. The playstation of claim 12, wherein the alignment members are substantially parallel to an edge of the bracket.

22. The bracket of claim 12, wherein the bracket includes a first and a second series of apertures extending therethrough, the first series of apertures configured to receive a first fastener to couple the bracket to a frame member and the second series of apertures configured to receive a second fastener different from the first fastener to couple the bracket to a frame member.

23. The playstation of claim 12, further comprising:
a third frame member;
a fourth frame member; and
a second bracket, substantially identical to the bracket, and including:
a first side;
a second side;
a first alignment member on the first side of the second bracket configured to align the third frame member with respect to the second bracket; and
a second alignment member on the second side of the second bracket configured to align the fourth fame member with respect to the second bracket;
wherein the first, second, third, and fourth frame members define a frame sub-assembly.

24. The playstation of claim 23, wherein the first and the second frame members define a left side of the frame sub-assembly and the third and the fourth frame members define a right side of the frame sub-assembly.

25. The playstation of claim 24, wherein a component extends between the left side and the right side of the frame sub-assembly.
